(19) United States
(12) Patent Application Publication
(10) Pub. No.: US 2006/0215565 A1
(43) Pub. Date: Sep. 28, 2006

(54) Method and apparatus to facilitate development of data packet-based accounting information

(75) Inventor: Michael Borella, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/088,479

(22) Filed: Mar. 24, 2005

(51) Int. Cl. H04J 1/16; H04L 12/26

(52) U.S. Cl. 370/241

(57) ABSTRACT

An apparatus (30), upon receiving a data packet at a network element interface (31), which data packet corresponds to a given network element, can use an accounting information processor (33) to develop specific accounting information regarding network usage on behalf of the given network element. For example, discrete accounting information can be developed to indicate whether data packets are blocked for forwarded as per the operations of a data packet filter (32). As another example, discrete accounting information can be developed to indicate the quantity of data packets as are handled for each of a plurality of different quality of service levels as ascertained by a quality of service-based data packet processor (34).

### TECHNICAL FIELD

This invention relates generally to communications networks and more particularly to data packet-based communications.

### BACKGROUND

Data packet-based communications comprises a relatively well-understood area of endeavor. Data packets can be used to convey essentially any bearer content including but not limited to voice content, application-based content such as files, and so forth. In many cases a network administrator will assess a corresponding fee based, at least in some respect, upon the number of data packets used by a given user over some period of time. In some cases a user may be limited to conveyance of no more than a given number of data packets per, for example, each month of usage. In other cases a user may pay incrementally increasing fees depending upon the number of data packets conveyed during the window of interest. In many cases such accounting procedures and criteria serve in a satisfactory manner.

There are scenarios, however, when presently used accounting techniques can lead to user and/or service provider dissatisfaction. For example, in many systems, data packets are counted for accounting purposes regardless of whether those data packets are actually forwarded to or from a given user or not. More particularly, many networks now include filtering capabilities intended to identify and divert (or block) some data packets from being forwarded.

For example, a Packet Data Serving Node may be configured with a filter intended to essentially block data packets that are identifiable as being unauthorized in some respect (by association with, for example, an unauthorized source or target, an unauthorized attempt to utilize a particular network service such as push-to-talk service, and so forth). Notwithstanding that some data packets may be filtered and blocked via such techniques, however, in many cases, a corresponding user will be charged for their pre-blocked presence. This can be puzzling to a user who sees a monthly statement indicating a considerably higher number of data packets being assessed as compared to a sense (or even a local count) of data packet usage as may be perceived by that user.

There are other problems involving present accounting techniques as applied to data packet services. For example, not all data services are created equal to one another in the sense that some data services require or benefit from a relatively better network facilitated quality of service. Time critical content (such as real-time video/audio content), for example, often benefits from a quality of service level of performance that tends to assure timely delivery of the data packets. Providing and/or meeting such quality of service standards, however, typically requires both network attention and network resources. At present, however, accounting for the usage of relatively higher (or lower) quality of service levels is practiced at a fairly high and gross level, if at all. As a result, many service providers are unable to track and account for such usage in a fair and equitable manner. This, in turn, can lead to lost income and/or overcharging in an attempt to cover the costs of supporting such higher tier services.

### BRIEF DESCRIPTION OF THE DRAWINGS

The above needs are at least partially met through provision of the method and apparatus to facilitate development of data packet-based accounting information described in the following detailed description, particularly when studied in conjunction with the drawings, wherein:

FIG. 1 comprises a flow diagram as configured in accordance with various embodiments of the invention;

FIG. 2 comprises a schematic view of a data packet as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, upon receiving a data packet that is associated with a given network element, which data packet has a corresponding specific quality of service level associated therewith and/or is to be forwarded on to a corresponding destination target, one develops accounting information with respect to that given network element as corresponds to that data packet as a function, for example, of the corresponding specific quality of service level and/or whether the data packet is, in fact, forwarded on to that destination target. Such accounting information is then preferably transmitted, for example, to an accounting server where the accounting information is preferably stored.

In a preferred approach, such accounting information is stored such that greater granularity and resolution of usage is achieved with respect to the overall quantity of handled data packets for that given network element. For example, the quantity of data packets as are handled with respect to the given network element for each of a plurality of quality of service levels can be separately maintained. As another example, the quantity of data packets that are forwarded as well as the quantity of data packets that were received but not forwarded can be similarly separately maintained.

So configured, those skilled in the art will appreciate that accounting information based on such data will permit improved and more accurate usage assessment. This, in turn, can facilitate both improved planning and support by the service provider as well as improved accounting transparency and visibility for the user.

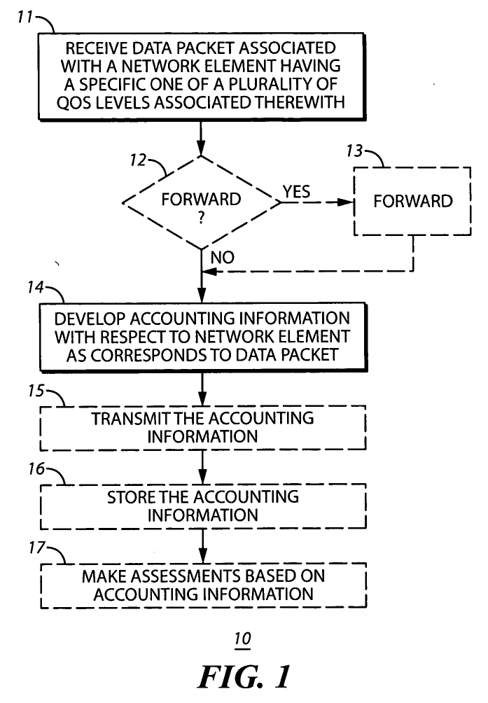

These and other benefits may become clearer upon making a thorough review and study of the following detailed description. Referring now to the drawings, and in particular to FIG. 1, a representative process 10 comprises receiving 11 a data packet that is associated with a given network element (in that, for example, the data packet is received from the given network element and is addressed to a subsequent recipient or is received from another source and is addressed to the given network element), wherein the data packet has a corresponding specific quality of service level associated therewith. In a preferred approach, this specific quality of service level is but one of a plurality of candidate quality of service levels that differ from one another. The particular quality of service level can and will vary with the needs, requirements, and/or capabilities that characterize a given application. Examples include, but are not limited to, different supported quantities of data, forwarding and/or routing priority, error coding, drop precedence, delay requirements, bit rate, number of flows, and so forth.

Upon receiving 11 such a data packet this process 10 can then optionally determine 12 whether to forward the data packet. This determination 12 can comprise, for example, a determination regarding whether the data packet contains data packet filter criteria as has been selected by the network administrator (as such filtering comprises a well understood area of endeavor, and as these teachings are not particularly sensitive to the selection or use of any particular filtering technique, further description of such filters will not be provided here for the sake of brevity). When the data packet comprises an acceptable data packet, this process 10 can then accommodate the forwarding 13 of that data packet to its final (or at least a next) destination in accordance with prior art practice in this regard.

This process 10 then provides for the development 14 of accounting information with respect to the given network element as corresponds to the data packet. In a preferred approach, this comprises developing the accounting information as a function, at least in part, of the corresponding specific quality of service level and/or as a function, at least in part, of whether the data packet has been (or will be) forwarded. In a preferred approach, this accounting information will reflect both a quantity of data as corresponds to the data packet as well as the above-indicated information.

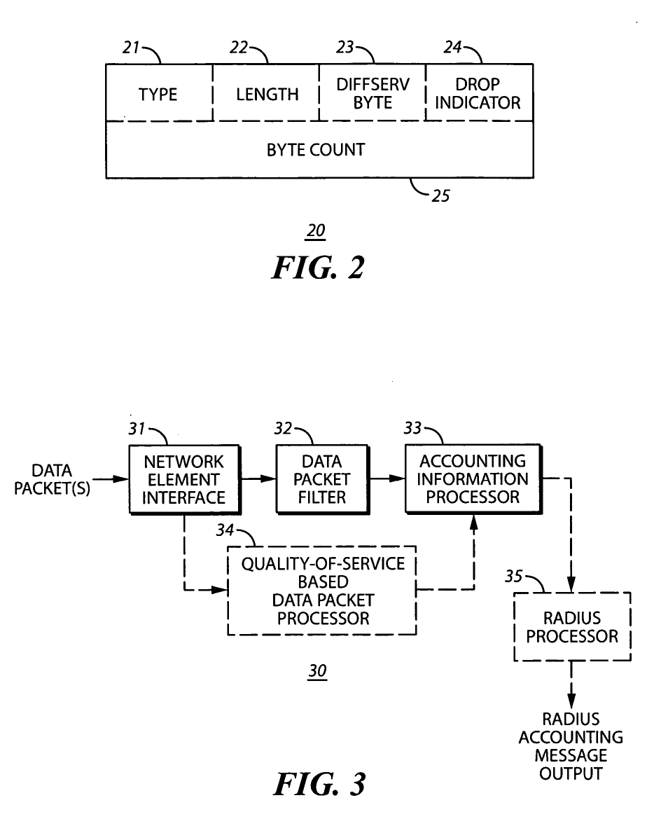

Such accounting information, once developed, can be configured in any of a wide variety of ways. By one illustrative approach a representative Remote Authentication Dial-In User Service (RADIUS)-styled accounting message can comprise a quality of service indicator that specifies the corresponding specific quality of service level. To illustrate, and referring momentarily to FIG. 2, the accounting message 20 can comprise, in addition to a type field 21 and a length field 22 to generally characterize the data packet, a DIFFSERV byte field 23 that serves, in this illustrative example, to specifically indicate a particular quality of service level to be accorded the data packet. Also, if desired, in addition to these fields and a byte count field 25, the accounting message 20 can further comprise a drop indicator 24 field to indicate whether the corresponding data packet was (or is to be) dropped or forwarded.

RADIUS accounting messages are generally understood and those skilled in the art will appreciate that only modest modifications and/or definitions need be applied to existing RADIUS protocols to accommodate such informational content. Those skilled in the art will further appreciate that the described RADIUS context serves an illustrative purpose only, and that such accounting information could be readily accommodated by any of a variety of other techniques.

Referring again to FIG. 1, this process 10 can then optionally provide for transmission 15 of the accounting information (for example, to an accounting server such as an Authentication, Authorization, and Accounting server as is known in the art) and/or storage 16 of the accounting information. Such storage can be effected locally and/or remotely and can further be accommodated using centralized or distributed facilities. As such storage options are well understood in the art, and as these teachings are useful with all such options without particular preference for any given single approach, further elaboration in this regard will not be provided here.

In a preferred approach, when storing 16 such accounting information, the accounting information is preferably stored such that information regarding a quantity of data as is received with respect to the given network element for each of a plurality of quality of service levels is separately maintained. For example, if, for purposes of illustration, one assumes there are three differentiated quality of service levels, then it may be useful to separately store, for accounting purposes, the quantity of data that is sourced by and/or targeted to the given network element for each of the three quality of service levels in a discrete and segregated fashion. In a similar fashion, accounting information regarding the quantity of data that is forwarded and/or that is not forwarded with respect to the given network element can also be separately maintained.

This process 10 can also optionally support the making 17 of assessments of an operating entity (such as a party of record as corresponds to the given network element) in an independent manner with respect to, for example, quantities of data as received different quality of service levels and/or that were forwarded or not forwarded. The previously developed accounting information will typically serve to facilitate the making of such assessments. For example, when the accounting information indicates a first discrete quantity of data received a first quality of service level and a second discrete quantity of data received a second, different quality of service level, a billing assessment can be made to the corresponding party that differentiates assessments with respect to such differences. For example, when the first quality of service level comprises a higher quality of service level than the second quality of service level, a higher charge can be assessed for the quantity of data that received the benefit of the first quality of service level.

So configured, these teachings permit a higher resolution view of network resource usage by a given network element. This view can include, when desired, an increased understanding of quality of service level usage and/or the extent to which data packets were forwarded or not forwarded with respect to a given network element accounting entity. These teachings are readily implemented with little or no modifications to local protocols and/or message formatting being necessary and further support relatively intuitive application in an accounting context.

Those skilled in the art will appreciate that the above teachings are implementable using any of a wide variety of enabling platforms, alone or in combination with one another (including both wholly or partially programmable platforms as well as dedicated-purpose platforms). Referring now to FIG. 3, an illustrative apparatus will be described.

This apparatus 30 may comprise, though is certainly not limited to, a Packet Data Serving Node (PDSN), a Home Agent (HA), a Gateway General Packet Radio Service Support Node (GGSN), a Digital Subscriber Line Access Multiplexer (DSLAM, a Cable Modem Termination System (CMTS), or the like. The apparatus 30 may comprise, in relevant part, a network element interface 31 of choice to receive data packets as described above and as are associated with a given network element such as, for example, a mobile station. The network element interface 31 operably couples, in this illustrative embodiment, to a data packet filter 32. The latter serves, in accordance with prior art technique, to determine whether to forward or not to forward received data packets using selection criteria of choice.

An accounting information processor 33 is then operably coupled to the data packet filter 32 to facilitate the development of accounting information as relates to the data packets as corresponds to network usage by the given network element that is associated with those data packets. So configured, and in a preferred approach, the accounting information processor 33 in particular develops discrete information regarding a quantity of data as is forwarded with respect to the given network element and a quantity of data as is not forwarded with respect to the given network element. Such information, in turn, can greatly facilitate a network usage assessment process that takes this parsed and discrete view of network usage into account.

If desired, in addition to (or in lieu of) the data packet filter-based accounting approach described above, the apparatus 30 can further optionally comprise a quality of service-based data packet processor 34 that also operably couples to the network element interface 31 and wherein the accounting information processor 33 is operably coupled to the quality of service-based data packet processor 34. So configured, the quality of service-based data packet processor serves, at least in part, to provide information regarding a quality of service level to be accorded to given data packets to the accounting information processor 33. The latter, in turn, can employ this information to develop accounting information as relates to the data packets and as corresponds to network usage by the given network element as measured, at least in part, by quantities of data as are received and/or processed for each of a plurality of quality of service levels.

As described earlier, it may be desirable to convey such accounting information to a remote location or recipient. To facilitate such conveyance, in this illustrative embodiment a RADIUS processor 35 is optionally operably coupled to the accounting information processor 33. The RADIUS processor 35 in turn provides a RADIUS accounting message output that can be compatibly supported using many known system architectures and configurations. Accounting information so conveyed can then be further employed for record keeping and/or billing purposes as desired.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
receiving a data packet associated with a given network element, which data packet has a corresponding specific quality of service level of a plurality of candidate different quality of service levels associated therewith;
developing accounting information with respect to the given network element as corresponds to the data packet as a function, at least in part, of the corresponding specific quality of service level.

2. The method of claim 1 wherein receiving a data packet associated with a given network element, which data packet has a corresponding specific quality of service level of a plurality of candidate different quality of service levels associated therewith comprises receiving a data packet having a quality of service level indicator that specifies the corresponding specific quality of service level.

3. The method of claim 2 wherein the quality of service level indicator comprises a diffserv byte.

4. The method of claim 1 further comprising:
transmitting the accounting information.

5. The method of claim 4 wherein transmitting the accounting information comprises transmitting the accounting information to an accounting server.

6. The method of claim 1 further comprising:
storing the accounting information such that information regarding a quantity of data as is received with respect to the given network element for each of a plurality of quality of service levels is separately maintained.

7. The method of claim 6 further comprising:
assessing an operating entity as corresponds to the given network element independently for different quality of service levels using the accounting information.

8. The method of claim 1 wherein receiving a data packet associated with a given network element further comprises at least one of:
receiving the data packet from the given network element as addressed to a subsequent recipient;
receiving the data packet, wherein the data packet is addressed to the given network element.

9. The method of claim 1 further comprising:
determining whether to forward the data packet; and wherein developing accounting information with respect to the given network element as corresponds to the data packet further comprises developing accounting information that reflects whether the data packet is forwarded.

10. A method comprising:
receiving a data packet associated with a given network element;
determining whether to forward the data packet;
developing accounting information with respect to the given network element as corresponds to the data packet as a function, at least in part, of whether the data packet is forwarded.

11. The method of claim 10 further comprising:
transmitting the accounting information.

12. The method of claim 11 wherein transmitting the accounting information comprises transmitting the accounting information to an accounting server.

13. The method of claim 10 further comprising:
storing the accounting information such that information regarding a quantity of data as is forwarded with respect to the given network element and a quantity of data as is not forwarded with respect to the given network element is separately maintained.

14. The method of claim 13 further comprising:
assessing an operating entity as corresponds to the given network element independently for forwarded and not forwarded data packets using the accounting information.

15. The method of claim 10 wherein receiving a data packet associated with a given network element comprises receiving a data packet having a corresponding specific quality of service level of a plurality of candidate different quality of service levels associated therewith; and wherein developing accounting information with respect to the given network element as corresponds to the data packet further comprises developing accounting information with respect to the given network element as corresponds to the data packet as a function, at least in part, of the corresponding specific quality of service level.

16. An apparatus comprising:
a network element interface that receives data packets as are associated with a given network element;
a data packet filter operably coupled to the network element interface where decisions regarding whether to forward or not to forward received data packets are made;
an accounting information processor operably coupled to the data packet filter that develops accounting information as relates to the data packets and as corresponds to network usage by the given network element, wherein the accounting information comprises discrete information regarding a quantity of data as is forwarded with respect to the given network element and a quantity of data as is not forwarded with respect to the given network element.

17. The apparatus of claim 16 wherein the apparatus comprises at least one of:
a Packet Data Serving Node (PDSN);
a Home Agent (HA);
a Gateway General Packet Radio Service Support Node (GGSN);
a Digital Subscriber Line Access Multiplexer (DSLAM);
a Cable Modem Termination System (CMTS).

18. The apparatus of claim 16 further comprising a Remote Authentication Dial-In User Service (RADIUS) processor operably coupled to the accounting information processor and having a RADIUS accounting message output.

19. The apparatus of claim 18 further comprising a quality of service-based data packet processor operably coupled to the network element interface and wherein the accounting information processor is operably coupled to at least one of the data packet filter and the quality of service-based data packet processor that develops accounting information as relates to the data packets and as corresponds to network usage by the given network element, wherein the accounting information comprises at least one of:
the discrete information regarding a quantity of data as is forwarded with respect to the given network element and a quantity of data as is not forwarded with respect to the given network element;
discrete information regarding a quantity of data as is received with respect to the given network element for each of a plurality of quality of service levels as may be associated with a given data packet.

20. The apparatus of claim 16 wherein the accounting information processor comprises means for developing accounting information that reflects at least one of:
a quantity of data as corresponds to the given network element for each of a plurality of quality of service levels;
a quantity of data as corresponds to the given network element that is forwarded and a quantity of data as corresponds to the given network element that is not forwarded.
